(19) United States
(12) Patent Application Publication
(10) Pub. No.: US 2012/0214332 A1
(43) Pub. Date: Aug. 23, 2012

(54) Charging Structure of Cigarette Lighter Plug

(76) Inventor: Yung HAN, Jhonghe City (TW)

(21) Appl. No.: 12/276,349

(22) Filed: Nov. 23, 2008

(30) Foreign Application Priority Data
Aug. 21, 2008 (TW) 097215049

(51) Int. Cl. H01R 11/11

(52) U.S. Cl. 439/504

(57) ABSTRACT

The present invention provides an improved charging structure of cigarette lighter plug, which includes a cigarette lighter plug, a power cord electrically connected to the cigarette lighter plug and at least one connector. The connector is at least provided with an outer casing, a voltage converter unit located inside the outer casing and electrically connected to the power cord, and a connector terminal located at one end of the outer casing and electrically connected to the voltage converter unit. Accordingly, integration of the voltage converter unit and the connector terminal reduces current flowing through the power cord, thereby downsizing of the cigarette lighter plug, decreasing wire gauge requirements of the power cord and achieving the effectiveness to lower manufacturing cost, as well as preventing the voltage converter unit from contacting the higher heat from the structure of vehicle, and increasing reliability and safety when in use.

### BACKGROUND OF THE INVENTION

(a) Field of the Invention

The present invention relates to an improved charging structure of cigarette lighter plug, and more particularly to a charging structure which enables downsizing a cigarette lighter plug, lowering charging current and decreasing wire gauge of a power cord. Thus, apart from achieving the effectiveness to lower manufacturing cost, moreover, the present to invention performs higher reliability and safety when in use.

(b) Description of the Prior Art

A cigarette lighter plug with charging function of the prior art (as depicted in FIG. 5) is structured to comprise a cigarette lighter plug 7, a voltage converter unit 71 located inside the cigarette lighter plug 7, a power cord 72 connected to the voltage converter unit 71, and a connector 73 connected to the power cord 72. Accordingly, the cigarette lighter plug 7 can be connected to a corresponding cigarette lighter jack of a vehicle, and the connector 73 can be connected to a related portable electronic equipment, thereby enabling the cigarette lighter plug 7 to obtain the required power when inserted into the cigarette lighter jack, and after the voltage converter unit 71 steps down the power source voltage, the power used as a charging source is input to the portable electronic equipment through the power cord 72.

Although the aforementioned cigarette lighter plug with charging function of the prior art can be used in a vehicle to acquire the electric power required by the portable electronic equipment, however, the voltage converter unit 71 is configured within the cigarette lighter plug 7, thus, manufacturing cost of the cigarette lighter plug 7 is inevitably hard to decreased. Moreover, the current output from the power source via the power cord 72 becomes higher after the voltage is stepped-down by the voltage converter unit 71. Therefore, it requires a larger wire gauge to be used as the power cord 72. Furthermore, because the voltage converter unit 71 is configured within the cigarette lighter plug 7, thus, the voltage converter unit 71 will quite possibly contact with the higher heat generated by the structure of the vehicle, thereby resulting in poorer reliability and affecting safety when in use.

### SUMMARY OF THE INVENTION

Hence, a primary objective of the present invention lies in using integration of a voltage converter unit and a connector terminal to enable reducing current output via a power cord and enhance power conversion efficiency, which apart from enabling reducing the size of a cigarette lighter plug, decreasing wire gauge requirements of the power cord and achieving the effectiveness to lower manufacturing cost, moreover, the present invention is able to prevent the voltage converter unit from contacting with the higher heat generated by the car, thereby ensuring the reliability and safety during the charging process.

In order to achieve the aforementioned objective, the present invention comprises a cigarette lighter plug, a power cord electrically connected to the cigarette lighter plug and at least one connector; wherein the connector is at least provided with an outer casing, a voltage converter unit located in the outer casing and electrically connected to the power cord, and a connector terminal located at one end of the outer casing and electrically connected to the voltage converter unit.

To enable a further understanding of said objectives and the technological methods of the invention herein, a brief description of the drawings is provided below followed by a detailed description of the preferred embodiment.

### BRIEF DESCRIPTION OF THE DRAWINGS

FIG. 1 is a schematic view of a first embodiment of the present invention.

FIG. 2 is a schematic view depicting application of the first embodiment of the present invention.

FIG. 3 is a schematic view of a second embodiment of the present invention.

FIG. 4 is a schematic view of a third embodiment of the present invention.

FIG. 5 is a schematic view of the prior art.

### DETAILED DESCRIPTION OF THE PREFERRED EMBODIMENTS

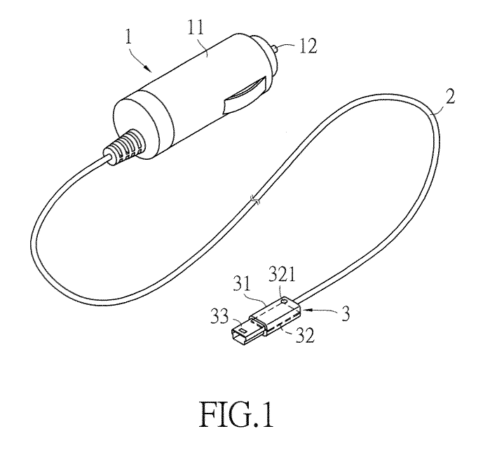

Referring to FIG. 1, which shows a schematic view of a first embodiment of the present invention, and as depicted in the drawing, the present invention is an improved charging structure of cigarette lighter plug, which is structured to comprise a cigarette lighter plug 1, a power cord 2 and at least a connector 3.

The aforementioned cigarette lighter plug 1 comprises a casing 11 and a conducting terminal 12 joined to the casing 11.

The power cord 2 is electrically connected to the conducting terminal 12 of the cigarette lighter plug 1.

The connector 3 comprises an outer casing 31, a voltage converter unit 32 located inside the outer casing 31 and electrically connected to the power cord 2, and a connector terminal 33 located at one end of the outer casing 31 and electrically connected to the voltage converter unit 32. Moreover, the voltage converter unit 32 is provided with an indicator light 321 located on the outer casing 31 to indicate the operating mode of the voltage converter unit 32. Accordingly, the aforementioned configuration presents a complete newly-improved charging structure of cigarette lighter plug.

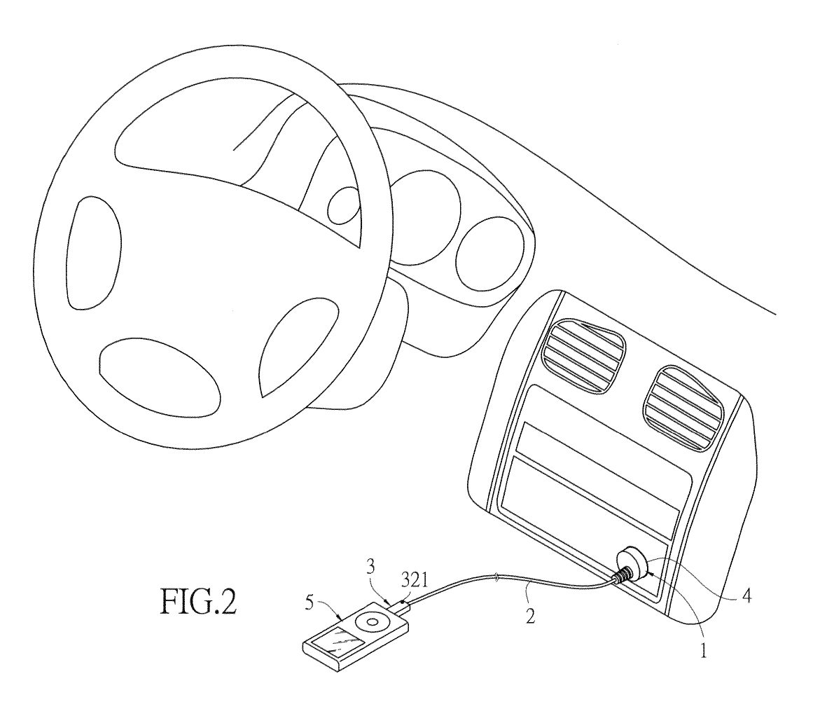

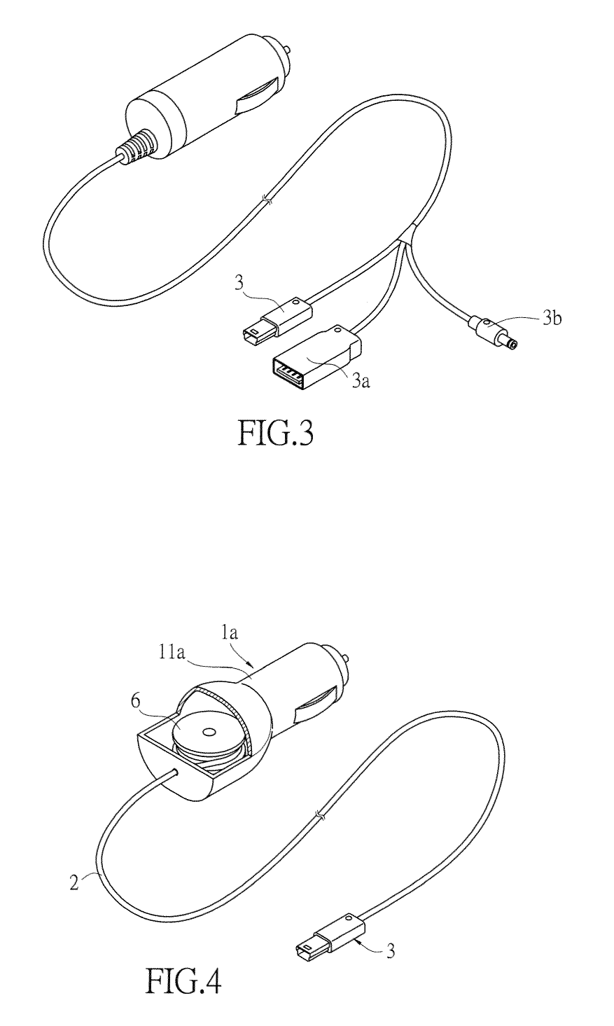

Referring to FIG. 2 and FIG. 3, which show a schematic view depicting application of the first embodiment and a schematic view of a second embodiment respectively of the present invention, and as depicted in the drawings, when using the present invention (referring together with FIG. 1), the cigarette lighter plug 1 is inserted directly into a corresponding cigarette lighter jack 4 of a vehicle, after which the connector terminal 33 of the connector 3 is connected to a related portable electronic equipment 5, thereby enabling the conducting terminal 12 of the cigarette lighter plug 1 to obtain the required power from the cigarette lighter jack 4, whereupon the power is then output from the cigarette lighter plug 1 to the connector 3 through the power cord 2, thus enabling the voltage converter unit 32 of the connector 3 to perform the required power conversion and further output designated power to the portable electronic equipment 5 to serve as the electric power source for operation and charging thereof. Moreover, the indicator light 321 is simultaneously used to display the operating mode of the voltage converter unit 32, and because the present invention integrates the connector terminal 33 with the voltage converter unit 32, thus, the present invention is able to at least achieve the following advantages:

1. Substantially reduces the manufacturing cost of the cigarette lighter plug 1.

2. Integration of the connector terminal 33 with the voltage converter unit 32 enables forming multiple shape variations of the cigarette lighter plug 1 (for example: character dolls, fishbone cable wraps, retractable wire winders, and so on) to meet users' needs. Moreover, the present invention is able to effectively prevent the cigarette lighter plug 1 from contacting with the higher heat generated from the structure of the vehicle, increasing efficiency, reliability and safety of power conversion when in use.

3. Current flowing from the cigarette lighter plug 1 to the power cord 2 is reduced, thus decreasing wire gauge requirements and lowering the cost of wire material.

4. The indicator light 321 is located on the connector 3, thus easily identifying whether or not the portable electronic equipment 5 is in a power conversion mode.

Furthermore, when the connector 3 is in actual use, connectors 3, 3a, 3b of many different specifications (as depicted in FIG. 3) can be configured integrally to the power cord 2 according to the needs of operation, thereby enabling the present invention to connect with other different portable electronic equipment 5, and further enabling the present invention to better meet selective needs.

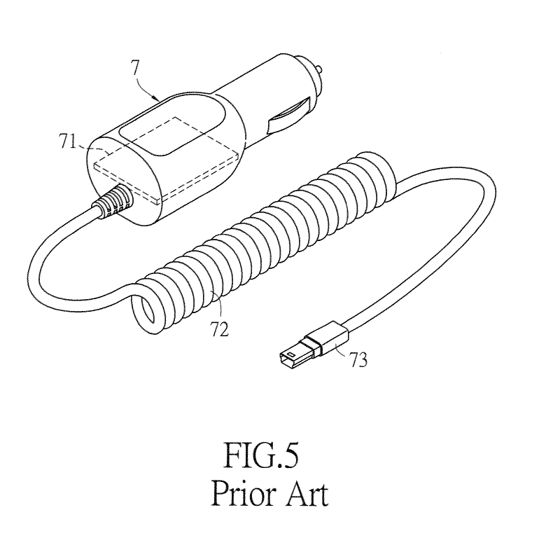

Referring to FIG. 4, which shows a schematic view of a third embodiment of the present invention, and as depicted in the drawing, when using the present invention, a wire winder 6 able to provide active winding of the power cord 2 is disposed inside a casing 11a of a cigarette lighter plug 1a. Accordingly, besides the aforementioned effectiveness, moreover, after using the connector 3, the wire winder 6 can be used to retract the power cord 2, thereby enabling the connector 3 to be placed in one end of the cigarette lighter plug 1a, or, when using the connector 3, joint structure of the power cord 2 and the wire winder 6 can be extended to a suitable length, thereby enabling the present invention to meet more function in use.

In conclusion, the improved charging structure of cigarette lighter plug 1 of the present invention is able to effectively improve the various shortcomings of the prior art using integration of a voltage converter unit 32 and a connector terminal 33 jointly configured in the connector 3 to enable reducing electric current flowing through the power cord 2, which apart from downsizing of a cigarette lighter plug 1, decreasing wire gauge requirements of the power cord 2 and achieving the effectiveness to lower manufacturing cost, moreover, the present invention is able to prevent the voltage converter unit 32 from receiving the higher heat generated from the vehicle and to improve power conversion efficiency when in operation. Therefore, the present invention assuredly complies with the essential elements as required for a new patent application. Accordingly, a new patent application is proposed herein.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A charging structure of cigarette lighter plug, comprising:
a cigarette lighter plug;
a power cord, the power cord is electrically connected to the cigarette lighter plug; and
at least one connector, the connector comprises an outer casing, a voltage converter unit located within the outer casing and electrically connected to the power cord, and a connector terminal located at one end of the outer casing and electrically connected to the voltage converter.

2. The charging structure of cigarette lighter plug according to claim 1, wherein the cigarette lighter plug comprises a casing and a conducting terminal joined to the casing and electrically connected to the power cord.

3. The charging structure of cigarette lighter plug according to claim 1, wherein the cigarette lighter plug comprises at least a casing, a conducting terminal joined to the casing and electrically connected to the power cord and a wire winder able to provide active winding of the power cord located in the casing.

4. The charging structure of cigarette lighter plug according to claim 1, wherein the voltage converter unit of the connector is provided with an indicator light located on the outer casing.
